(19) United States
(12) Patent Application Publication
(10) Pub. No.: US 2010/0214093 A1
(43) Pub. Date: Aug. 26, 2010

(54) WIRELESS MESSAGING SYSTEM FOR PARENTS AND CHILDREN

(76) Inventor: Gene A. Williams, Harrison, OH (US)

Correspondence Address: HARRINGTON LAW OFFICE, SUITE 350, 5300 CORPORATE GROVE DR SE., GRAND RAPIDS, MI, 49512, US

(21) Appl. No.: 12/392,264

(22) Filed: Feb. 25, 2009

(51) Int. Cl. G08B 1/08

(52) U.S. Cl. 340/539.11

(57) ABSTRACT

A novel wireless messaging system for use in sending discrete messages between a parent and a child, is comprised of a master unit (parent) and a remote unit (child) where the master unit has a plurality of pre-set messages that can be sent by radio transmission to the remote unit. The remote unit will process the received message and will then activate the appropriate message as a visual indication on the face of the remote unit. The remote unit has the capability of sending at least one message to the master unit, which is typically a “Help” message that is received and processed by the master unit and converted into an alert.

The wireless messaging system of the present invention is preferably battery powered thus allowing for mobility. The remote unit is also optimized for use by a child so that it can be attached to an article of clothing and such that it will withstand impacts.

The wireless message system of the present invention may include a protocol where the remote unit has visual and/or audible alarms activated in the event the “Help” button is depressed. This provides additional signals that may assist the parent in searching for their child.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a pager/messaging device for use between a parent and a child. More particularly, the present invention relates to devices and a method for paging and sending pre-set messages between at least a pair of transceivers.

The advent of wireless communications has opened the door to numerous devices and applications. The thought of a mobile phone as small as a deck of cards was once the kind of science fiction “toy” that was seen only in the movies. Now cell phones are an established way of life even to the point of distraction. Cell phones are being regulated in a number of places, including the classroom, movie theatres, places of business, and the like. As much as the cell phone is a great convenience, it can be a great annoyance as well.

One area where cell phone seems to be of concern is the potential for abuse or overuse by children or even teenagers. Many parents have found that cell phones are of great use in keeping track of their children whether this is at the shopping mall, at a sporting event, or in an amusement park, to name a few such locations. It is a simple matter for the parent to dial the son or daughter's cell phone number and determine their location or to make a time to meet. The cell phone also provides a way for a person, whether it is the parent or the child, to call for help in the event of an emergency, which has clearly been one of its more appreciated functions. Again though, there are many environments where cell phones are simply not welcome and cannot be used. In addition, there are times when a parent may be reluctant to arm his/her child with a cell phone, worrying about the avalanche of charges that will result because of uncontrolled usage.

Various parent-child messaging system are known in the prior art including a system disclosed in U.S. Pat. No. 6,593,851 (Bornstein) which teaches a communication system capable of sending and receiving signals. One of the units in the Bornstein invention is directed for use by a child and one for the parent. Voice and vibratory alerts can be sent and LEDs are provided in the child's unit to indicate status situations such as “green” to show the unit is operational and no signal from the parent has been received, or “orange” to indicate that the child's unit is out of range of the parent's device, or “red” to indicate a signal from the parent that needs to be attended to. The Bornstein devices do function to provide some level of messaging between parent and child, but the messages are not specific and the child needs to follow-up to determine what the parent desires. In some instances audible alerts may be provided with the Bornstein device but these are in the nature of alarms and not messages. Unlike the present invention, the Bornstein system does not provide visual messaging that can be easily interpreted by children of very young years. Nor does the Bornstein device provide a “help” call in the manner of the present invention.

Another child related device is shown in U.S. Pat. No. 5,652,569 (Gerstenberger, et al) where a wireless message system is employed to provide a signal that interprets the child to be “safe” so long as the signal is received and therefore within range of the parent's receiver. If the child wanders too far then the lack of signal is sensed resulting in an alarm being raised at the parent's unit. The child's device can be mated to his/her backpack as well such that another alarm can be triggered if the backpack is removed. Gerstenberger does not teach a receiving unit for a child that visually (and otherwise) communicates a message for the child to respond to.

A simpler parent-child communication system is shown in U.S. Pat. No. 5,923,255 (Vahdatshoar) where the child is fitted with a sending unit that can trigger an alarm on a corresponding receiving unit held by the parent. The sending unit will simultaneously raise an alarm which can be disarmed by a key carried on the parent's receiving unit. Vahdatshoar does not teach a visually active system for messaging between a parent and child.

In U.S. Pat. No. 6,265,974 (D'Angelo, et al) a parent and child sensing system is disclosed where the distance between the parent and child is monitored and when the child wanders out of range an alarm is triggered. In U.S. Design Pat. No. D423,010 (Wicks) a pager design is displayed of roughly oval shape but which does not function as a device that is fastenable to a child. The guardian control system taught in U.S. Pat. No. 5,337,041 (Friedman) teaches a one-way system that allows a guardian to trigger an alarm on the receiving unit worn by a child, pet or someone under the care of the guardian. The signal can issue voice messages saying “I'm lost” and/or it can cause strobe lights to flash and the like. Nearby persons can then recognize that the person or pet needs assistance.

Other devices are known such as the newest generation of walkie-talkies that possess higher quality voice transmission capabilities and varying degrees of signal range. These walkie-talkies are useful for staying in voice contact with another person but they do not provide the visual messaging. The temptation for children especially is to use the walkie-talkie for purposes other than parent-child communications.

The need exists for a parent-child communication tool that is easy for the child to use, which provides the appropriate types of messages for the child, and which has a method for imparting the message that will easily inform the child what response the parent wants. It is also important that a parent-child messaging system includes provisions for the child to trigger a “help” alarm so the parent can respond.

### SUMMARY OF THE INVENTION

A novel wireless message system for communication between a parent and a child, comprises a master unit and a remote unit where the master unit is capable of sending a plurality of messages to the remote where they are displayed in a visual manner. The remote, on the other hand, is capable of sending a help message to the master unit where the help message is displayed visually. The remote unit is preferably carried by the child and has a simplistic construction with minimal inputs. The master unit has a plurality of inputs corresponding to the messages that may be sent to the remote unit.

Both the master unit and the remote unit of the present invention are battery powered for portability. In addition, audible alerts and/or vibratory alerts may be added to the messages in order to ensure that the recipient becomes aware of the communication.

### BRIEF DESCRIPTION OF THE DRAWINGS

FIG. 1 is an isometric view of the front sides of the remote unit and the master unit of the wireless message system of the present invention.

FIG. 2 is a rear isometric view of the remote unit and the master unit of FIG. 1.

FIG. 3 is a partial front view of a remote unit of the present invention, showing the function of the clasp.

FIG. 4 is a schematic showing at least one way to organize the functions that can be offered by the master unit and the remote unit of the message system of the present invention.

### DETAILED DESCRIPTION OF THE PREFERRED EMBODIMENTS

A wireless message system in accordance with the present invention is shown in the drawings and is described herein. The wireless message system is intended to provide a way for a parent to reach a child with a message under various circumstances. For example, the child can be playing with friends in the neighborhood and the parent desires to have them come back home for dinner. The parent, when using the present invention, can transmit a signal to the remote unit which is converted into a visual message that might say “Come Home Now.” The child may not necessarily be able to read and will pick up the meaning of the visual by its location on the face of the remote unit. Other examples as to how the present invention may be deployed include the use of the wireless message system at amusement parks, shopping malls, and sporting and school events.

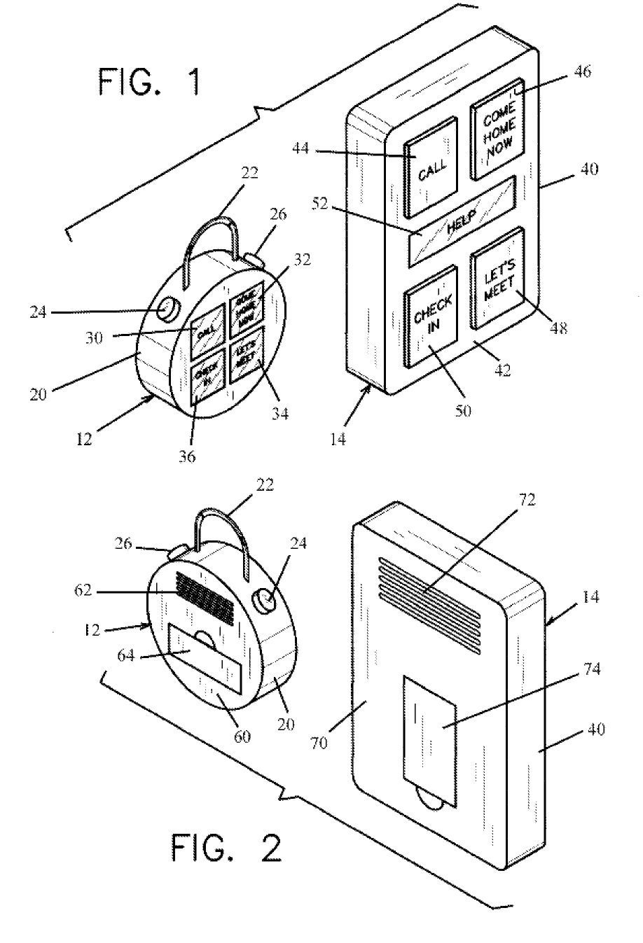

Turning now to the drawings, FIG. 1 shows the message system 10 which is comprised of the remote unit 12 and the master unit 14. The remote unit 12 includes the remote body 20, the remote clasp 22, the help button 24, and the stop button 26. The remote unit 12 further includes a front side 28 with a display that includes a “Call” indicator 30, a “Come Home Now” indicator 32, a “Let's Meet” indicator 34, and a “Check In” indicator 36. The master unit 14 includes the master body 40, the master front 42, the “Call” button 44, the “Come Home Now” button 46, the “Let's Meet” button 48, the “Check in” button 50 and the “Need Help” indicator 52.

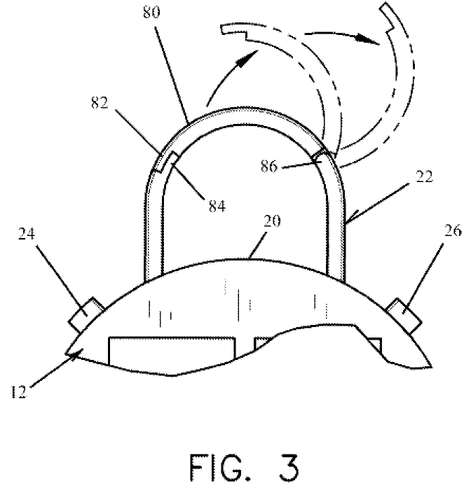

FIG. 2 is the reverse side of the remote unit 12 and the master unit 14 shown in FIG. 1, and with respect to the remote unit further reveals the remote back 60, the remote vents 62, and the remote battery access 64. The master unit 14 is shown with the master back 70, the master vents 72 and the master battery access 74. FIG. 3 is a detailed view of a portion of the remote unit 12 showing the remote clasp 22 with the clasp latch 80, the clasp latch end 82, the clasp end 84 and the hinge portion 86. The use of the present invention may be somewhat intuitive which is by design since it is intended, in part, to be used by children. The remote unit is offered as a simple package that can be attached to the belt buckle of the child so it can be accessed when needed yet it won't be easily lost. The remote body has a clasp that can snap-fit onto the loop of the child making it easy for attachment purposes yet affirmatively attached while in use. The remote unit is primarily set up for the reception of signals from the master unit. The parent can send any one of a number of pre-set messages, such as “Check In” by depressing the corresponding button on the master unit. The signal will be sent out and will be received by the remote unit (so long as it is turned on and in range) and is processed and will result in the triggering of an alert. In the preferred mode of practice, the alert will be a vibration and the energizing of an indicator light corresponding to the message “Check In.” The light may be flashing or it may be constant, but it is noted that the light is associated with the appropriate indicator that reports that particular message, i.e., it has the message printed on it. This message is displayed as part of the light typically of the type of panel indicators that are found in many devices, for example, on the dashboard of a motor vehicle. These indicators may be integrated with the remote (or master) body or they may be separate light assemblies. Of particular interest is the usage of LED lights for this purpose since they can be obtained with high light output while consuming very little battery power. In any event, the youngster will know the nature of the message and will understand that his/her parent is asking for them to respond accordingly.

The messaging between the parent and child is primarily one way, where the parent is sending and the child is receiving. In one instance though, the child has the “Help” button available on the remote which, when depressed, will cause a signal to be emitted by the remote unit which will be received by the master unit. The signal will be processed and results in an alert, typically comprising a vibration and the energizing of an indicator light (in the manner discussed above) corresponding to the “Help” message.

The alerts for the remote unit and/or the master unit may additionally be selected as an audible indication. A constant “buzz” or tone can be used to flag the recipient that a message has been received. When any alert has been acknowledged the recipient can turn off the indication by using the stop button in the case of the remote, or by using any of the message buttons on the master unit. In a variation on this protocol, it is possible to fix the remote so that the audible alert remains on when the child has used the “Help” button thus allowing the parent to search for the child by means of the alarm.

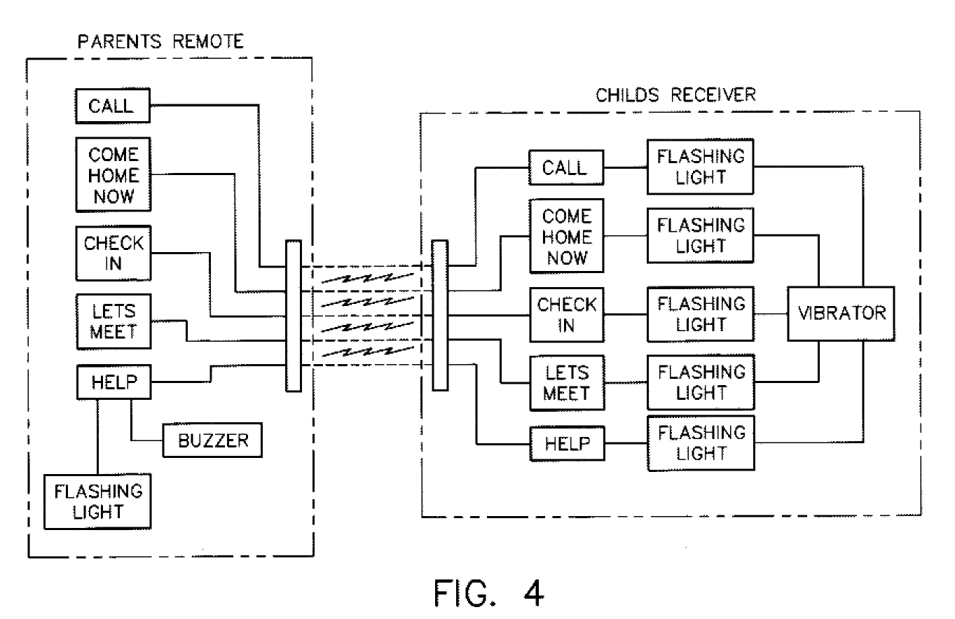

The remote unit and the master unit are both preferably powered by a battery, which may be a rechargeable battery source. Portability of both units is desired since this would allow them to be used in many different scenarios as described above. The remote body and the master body are both preferably fabricated from a plastic that is robust enough to withstand the impacts of use. The circuitry that generates and the processes the signals corresponding to the messages is within the scope of one skilled in the art and is not specifically a part of the present invention except as needed to provide the functions described herein. However, an example of one way in which the present invention can be practiced is shown in FIG. 4. The “Master” portion of the schematic shows the functions available to the parent as the various message buttons, “Call”, “Come Home Now”, “Check In”, and “Let's Meet”. The outputs from these buttons are shown as being directed outside the Master portion by wireless transmission (shown by the jagged lines) and which are received and processed by the “Remote” portion into the corresponding indicators. In this instance, the alerts that are enabled are the flashing light and the vibratory alerts. The “Help” button provided on the Remote portion runs counter to the rest of the message paths in that it sends a signal back to the Master portion. Upon receipt by the Master, the signal is processed and results in similar alerts, a flashing light and a buzzer.

The scheme discussed for FIG. 4 can be modified in any number of ways. For instance, the actual message that is pre-set can be changed. In fact, the present invention can be supplied with components to allow the parent to make specific messages which would be fitted onto the corresponding buttons (Master) and the indicators (Remote) as may be desired. As mentioned above, the types of alerts can be changed too. In fact the alerts can be made to follow any protocol that could be desired, for instance, the vibratory alarm, the light alarm and the audible alarm can all be triggered and can be made to operate intermittently or constantly. The objective in some cases may be to ensure that the recipient is alerted, or in some cases (where the “Help” button has been depressed) to provide some indication as to where the child is.

Typically the wireless units of this type will operate on public broadcasting bands that are set aside for walkie-talkies and the like. The wattage output is restricted by law but current technology does allow such units to transmit and receive over a range of up to five miles or more. They can use the same radio frequencies as public uses since the transmissions are coded for processing by the receiving unit (typically the remote). The processing breaks down the transmission and then activates the appropriate message. For most uses, the wireless messaging system of the present invention will be operating within ranges far less than five miles. The typical system only receives a signal when one is manually sent. There are circumstances where signals could automatically be triggered, such as low battery conditions, or time-out conditions where the units have been left on for a prolonged period of time.

The teachings regarding the present invention are meant to illustrate the functions it can provide in various applications. The explanations and examples are meant to illuminate these uses and are not meant to limit or inhibit the scope of the invention in any way.

I claim:

1. A wireless messaging system for use between a parent and a child, where the wireless messaging system comprises:
A battery powered master unit for the primary transmission of a signal representing one of a plurality of pre-set wireless messages by a parent;
A battery powered remote unit for use by a child for the receipt of said signal transmitted from the master unit, where the remote unit processes the received signal into an alert that includes at least a visual indicator corresponding to one of each of such pre-set wireless messages as may be transmitted from the master unit; and,
Where the remote unit has the capability of transmitting a signal representing at least one pre-set wireless message and where the master unit processes the received signal transmitted from the remote unit into an alert that includes at least a visual indicator corresponding to the pre-set message transmitted from the remote unit.

2. The wireless messaging system of claim number 1, where the alerts comprising the visual indicators for the master unit and for the remote unit are lighted displays showing the pre-set message thereon.

3. The wireless messaging system of claim number 2, where the alerts also include an audible alarm.

4. The wireless messaging system of claim number 2, where the alerts also include a vibratory alarm.

5. The wireless messaging system of claim number 1, where the remote unit includes a clasp for attaching the remote unit to the clothing of a child.

6. The wireless messaging system of claim number 1, where the pre-set message transmitted by the remote unit is “Help.”

7. The wireless messaging system of claim number 1, where the pre-set message transmitted by the master unit is a message selected from the group of “”Call” or “Come Home Now” or Let's Meet” or “Check In.”

8. A wireless messaging system for use between a parent and a child, where the wireless messaging system comprises:
A battery powered master unit for the primary transmission of a signal representing one of a plurality of pre-set wireless messages by a parent;
A battery powered remote unit for use by a child for the receipt of said signal transmitted from the master unit, where the remote unit processes the received signal into an alert that includes at least a visual indicator corresponding to one of each of such pre-set wireless messages as may be transmitted from the master unit;
Where the remote unit has the capability of transmitting a signal representing at least one pre-set wireless message and where the master unit processes the received signal transmitted from the remote unit into an alert that includes at least a visual indicator corresponding to the pre-set message transmitted from the remote unit; and,
Where the alerts comprising the visual indicators for the master unit and for the remote unit are lighted displays showing the pres-set message thereon.

9. The wireless messaging system of claim number 8, where the alerts also include an audible alarm.

10. The wireless messaging system of claim number 8, where the alerts also include a vibratory alarm.

11. The wireless messaging system of claim number 8, where the remote unit includes a clasp for attaching the remote unit to the clothing of a child.

12. The wireless messaging system of claim number 8, where the pre-set message transmitted by the remote unit is “Help.”

13. The wireless messaging system of claim number 8, where the pre-set message transmitted by the master unit is a message selected from the group of “”Call” or “Come Home Now” or Let's Meet” or “Check In.”

14. A wireless messaging system for use between a parent and a child, where the wireless messaging system comprises:
A battery powered master unit for the primary transmission of a signal representing one of a plurality of pre-set wireless messages by a parent;
A battery powered remote unit for use by a child for the receipt of said signal transmitted from the master unit, where the remote unit processes the received signal into an alert that includes at least an audible alarm and a visual indicator corresponding to one of each of such pre-set wireless messages as may be transmitted from the master unit;
Where the remote unit has the capability of transmitting a signal representing at least one pre-set wireless message and where the master unit processes the received signal transmitted from the remote unit into an alert that includes at least an audible alarm and a visual indicator corresponding to the pre-set message transmitted from the remote unit; and,
Where the alerts comprising the visual indicators for the master unit and for the remote unit are lighted displays showing the pres-set message thereon.

15. The wireless messaging system of claim number 14, where the alerts also include a vibratory alarm.

16. The wireless messaging system of claim number 14, where the remote unit includes a clasp for attaching the remote unit to the clothing of a child.

17. The wireless messaging system of claim number 14, where the pre-set message transmitted by the remote unit is “Help.”

18. The wireless messaging system of claim number 14, where the pre-set message transmitted by the master unit is a message selected from the group of “”Call” or “Come Home Now” or Let's Meet” or “Check In.”
